(19) United States
(12) Patent Application Publication
(10) Pub. No.: US 2005/0149359 A1
(43) Pub. Date: Jul. 7, 2005

(54) Method, apparatus and computer readable medium for identifying health care options

(76) Inventors: Earl P. Steinberg, Chevy Chase, MD (US); Harry Soza, San Jose, CA (US); James D. Frankfort, Gilroy, CA (US)

Correspondence Address: David H. Schaumann;Arnold & Porter LLP, 555 Twelfth Street, N.W., Washington, DC, 20004-1206, US

(21) Appl. No.: 10/995,090

(22) Filed: Nov. 24, 2004

Related U.S. Application Data
(60) Provisional application No. 60/528,816, filed on Dec. 12, 2003.

(51) Int. Cl. G06F 17/60

(52) U.S. Cl. 705/2; 705/3

(57) ABSTRACT

The present invention is directed to methods, apparatuses and computer readable media for identifying health care options that benefit patients and reduce costs associated with providing health care for those patients.

### CROSS REFERENCE TO RELATED APPLICATIONS

This application claims benefit under 35 U.S.C. §119 of Provisional Application Ser. No. 60/528,816, filed Dec. 12, 2003.

### FIELD OF THE INVENTION

The present invention relates to health care information systems. In particular, the present invention is directed to identifying health care options for patients that may enhance the health care that they will receive in the future.

### BACKGROUND OF THE INVENTION

The complexity of modern day health care often leaves a patient and his or her doctors without an effective means of tracking the patient's health care over time or identifying particular health care options that are likely to enhance the quality or safety of, or reduce the costs associated with providing health care for that patient. It is often the case that patients have no means of identifying health care options, which may be available to them, without a detailed consultation with their doctor or other health care provider. What is needed is a automated technique for conveying timely health care information, including low cost health care options, to a patient and their doctors in a manner which takes into account their own unique medical history and insurance benefits. Preferably, the health care information is conveyed in a cost-effective format that is convenient for the user of that information, whether that user be the patient or his or her doctors or individuals working on behalf of health insurance companies or health plans.

In addition to providing timely health care information for patients and their doctors, it is typically the case that consumers of health care information, including insurance companies, hospitals and doctors, would like to identify those patients for whom future health care costs may be reduced through enhanced health care or for whom the quality of health care may be improved. Thus, what is needed is an automated technique for identifying such patients along with recommendations for selecting specific health care options having a tendency to reduce future health care costs for patients or for whom the quality of health care may be improved.

### SUMMARY OF THE INVENTION

The present invention is directed to a method, apparatus and computer readable medium for identifying health care options that benefit patients and reduce costs associated with providing health care for those patients. The invention is best understood with reference to the specification, drawings, claims and the contents of the CD containing the files listed in Appendix 6 that is filed herewith. The CD, along with Appendices 3-8 which are incorporated herein by reference, contain source code and other information helpful to an understanding of the invention and its implementation.

### BRIEF DESCRIPTION OF THE DRAWINGS

FIG. 1 is a block diagram of an overall system according to the present invention.

FIG. 2 is a block diagram of a cost reduction analysis according to the present invention.

FIG. 3 is a sample rule report according to the present invention.

FIG. 4a is a block diagram of patient information according to an embodiment of the invention.

FIG. 4b is a diagrammatic presentation of the information associated with a recommendation in accordance with an embodiment of the present invention.

FIG. 5a is a sample patient report according to the present invention.

FIG. 5b is a sample backside of a patient report according to the present invention.

FIG. 6a is a sample physician's report according to the present invention.

FIG. 6b is a sample backside of a physician's report according to the present invention.

### DESCRIPTION OF PREFERRED EMBODIMENTS OF THE INVENTION

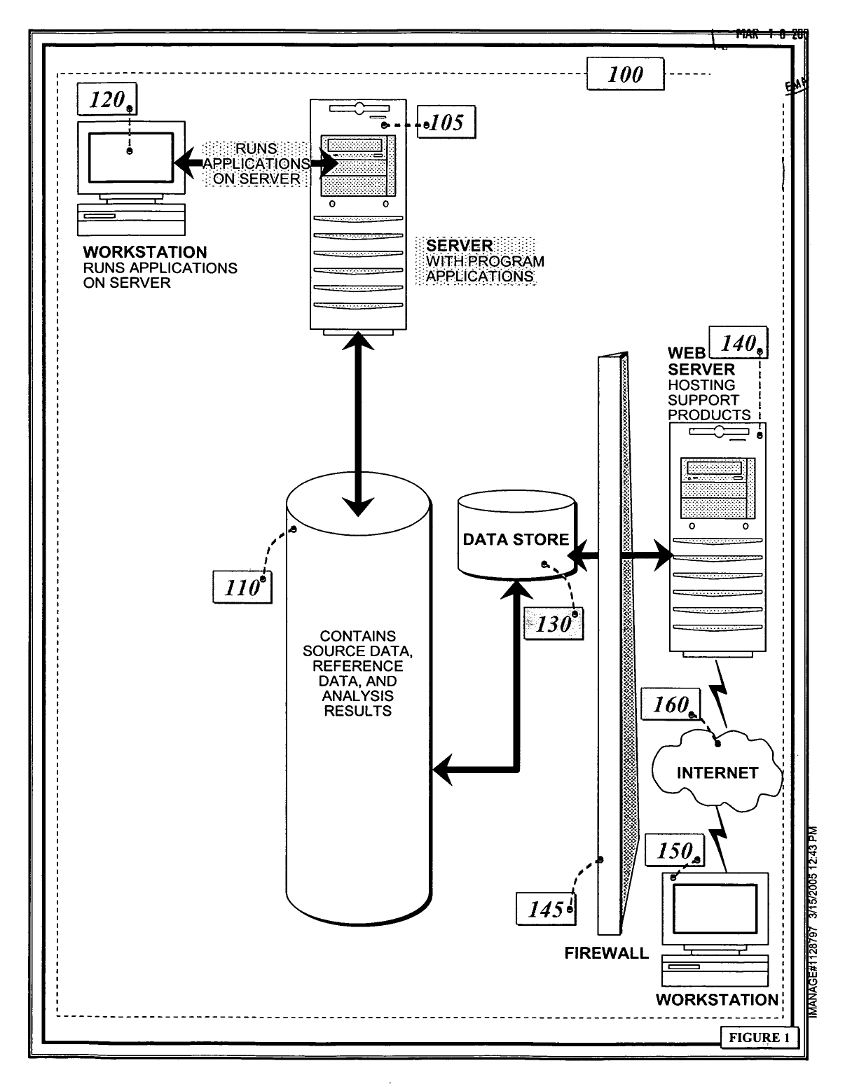

The present invention may be implemented in a computer system 100, as shown in FIG. 1. The computer system 100 includes a computer server 105 (such as MSQL 2000), which stores program applications that are employed in carrying out the present invention. One or more of these programs, which may be run by a workstation 120 (or other computer) coupled to the computer server 105, implement a rules engine or inference engine that permits the application of various rules to source data, such as insurance claims and medical data pertaining to patients, that is stored in a database 110 (or multiple databases), such as a relational database, that is coupled to the client server 105. By way of example, the database 110 may reside on the computer server 105 or may be on a database server (not shown) that is accessible via a network, such as a local area network, wide area network, or wireless network. Program applications may be stored on various electronic media, such as hard drives, floppy drives, or other computer readable media known in the art.

The database 110 may also store reference data that is employed in connection with the application of the rules to the source data stored therein. The database 110 may also store the analysis results, which result from the application of the rules to the source data stored therein. The reference data may include formatted and/or unformatted industry standard insurance or medical codes, or a representation thereof, which are useful in implementing the rules. The reference data may also include information describing health care providers, such as hospitals and doctors, as well as their specialties.

The computer system 100 also includes a data store 130, which may be optionally employed for large sets of source data and corresponding analysis results. The data store 130 may be coupled to the database 110 via a network. The data store 130 may be implemented as a data warehouse or data mart. If access to the database 110 or (if utilized) the data store 130 is to be provided via the Internet, then a web server 140 may be employed that includes one or more program applications that provide reports generated by embodiments of the present invention. The reports may be provided as web pages (e.g., HTML or XML based web pages), which are made accessible to a web browser residing on a workstation 150 (or other computer) that is coupled to the web server 140 via the internet 160. The reports are provided in response to user requests from the web browser. These requests may be authenticated by the web server to ensure that the person is authorized to review the information requested. Optionally, a firewall 145 may be provided between the web server 140 and the database 110 or data store 130 (if utilized).

As an alternative to the use of the web server 140, reports generated by the present invention may be provided by one or more program applications residing on the computer server 105 or workstation 150.

In accordance with an embodiment of the present invention, health care information is received for a plurality of patients. This patient information can be received from many different sources as well, as will be apparent to one having skill in the art. In accordance with an embodiment of the present invention, these sources could include records from an insurance company or program sponsor, or from individual patients through biometric data sent over a telephone line, or clinical data reported by physicians for example. The health care information can be analyzed to determine health care options that may have a tendency to reduce future health care costs for individual patients, or improve the quality of care for the patient.

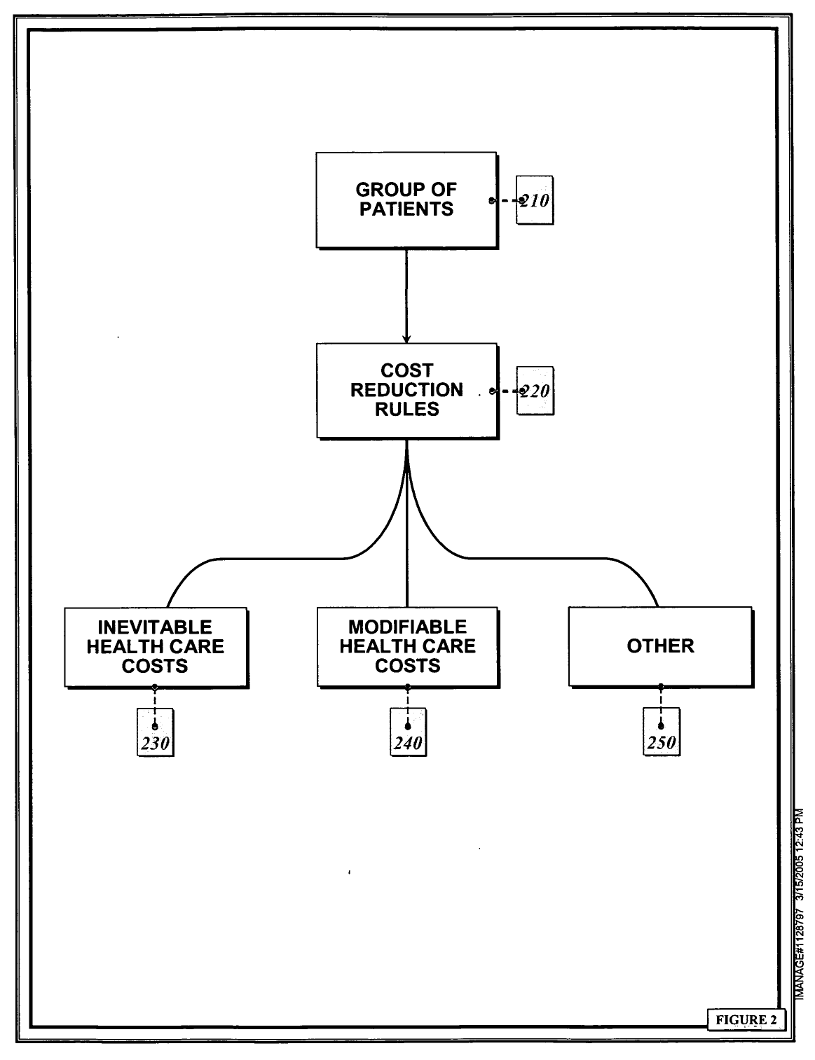

Turning now to FIG. 2, a group of patients 210 is selected. The group of patients 210 may include one or more patients.

In accordance with an embodiment of the present invention, the group of patients 210 may be selected based on the predicted costs of their future health care or based on some other predefined characteristic, such as a predefined characteristic of the patient. A health care provider or insurance company can predict the future health care costs for each of the patients associated with the health care provider or insurance company. By way of example, the top one percent of these patients, in terms of cost, can be selected to be in the group of patients 210.

However, the patients need not be ranked by their predicted future health care costs, or any other predefined characteristic, such as a predefined characteristic of the patient, for the present invention. As such, any group of patients may be selected to facilitate the present invention.

A set of cost reduction rules 220 may be applied to each patient in the group of patients 210. The cost reduction rules 220 are designed to evaluate patients based on historical health care data, and provide recommendations that can reduce the costs associated with future health care. Other types of rules may be utilized, such as those that recognize the opportunity to increase the quality of health care provided to a patient. (An example of rules according to an embodiment of the invention that might be used for this can be seen below under the heading Brief Description of the Rules and Identification of the Embodiments to Which they Pertain under checkbox column “1”).

Historical health care data is linked to a unique patient identification number. When one of the cost reduction rules 220 is applied to the data for a particular patient, a recommendation may be generated based upon the outcome of the rule, and the recommendation may be linked to the patient's unique identification number to facilitate the later retrieval of the patient's information.

When all the rules have been applied to each of the patients, the patients can be separated into groups. By way of example, the patients may be separated into the following three groups: (a) Patients whose conditions dictate that their future health care costs are likely not modifiable, and therefore inevitable 230; (b) Patients whose conditions indicate that there are modifications that could be made to reduce costs 240 (or to increase the quality of health care provided.); and (c) Patients who fall in neither category (a) nor category (b) 250.

The patients whose conditions dictate that their costs are likely not modifiable 230 are patients who have certain predefined conditions. According to an embodiment of the present invention, the conditions could be determined through surveys of health care professionals. These conditions may include, for example, the occurrence of a transplant in the previous twelve months, or the start of hospice in the preceding four months. Alternatively, it could be determined that no predefined conditions automatically dictate that costs are not likely modifiable. For those patients who meet the conditions that are defined to automatically dictate that costs are not likely modifiable, rules could be developed to place patients in category (a).

Patients are placed in category (b) 240 if they do not have a condition that would put them in category (a) and one or more of the rules applies, resulting in one or more links between cost reducing recommendations and the patient's unique patient identification number.

Category (c) 250 contains all the remaining patients who do not have the conditions for category (a), but also have no cost reducing recommendations linked to their patient identification number following the application of the rules.

The patients in category (b) 240 are then included in a report describing the changes that could be made to reduce future health care costs. This report may be used by health care providers and insurance companies to directly contact the individual patients by telephone or email, for example, to discuss possible cost saving changes to their health care choices.

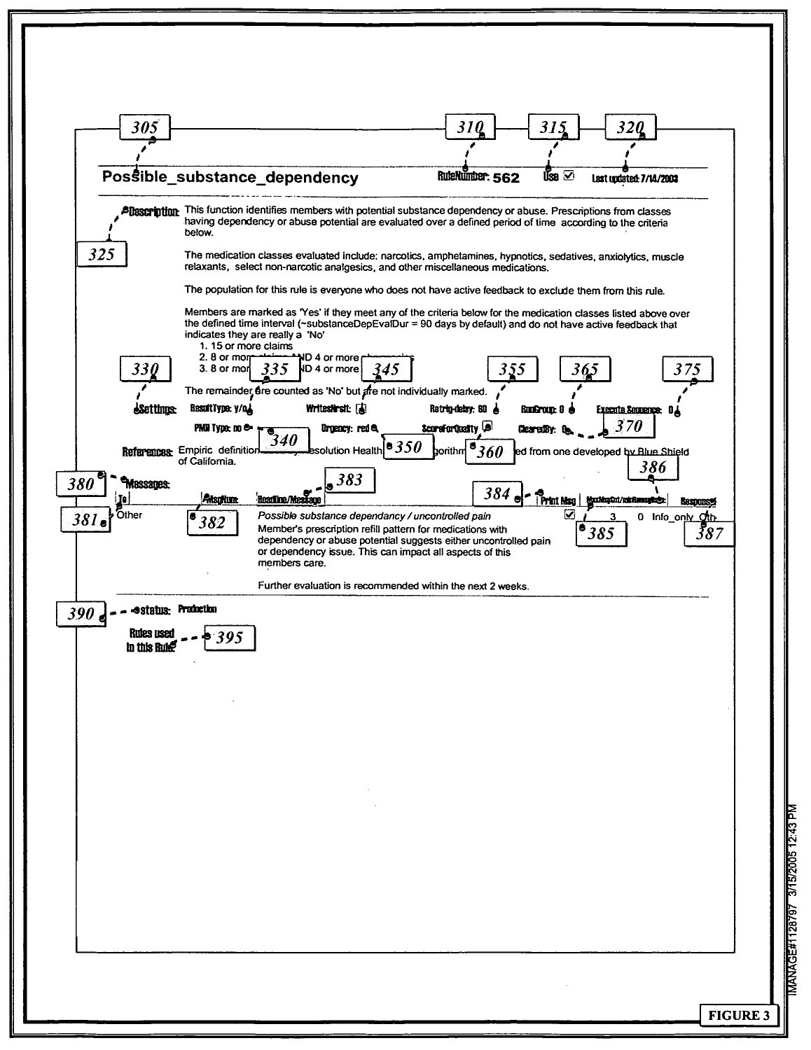

An example of a rule described above may be a rule that predicts whether or not a patient has a substance dependency or is engaged in substance abuse. Turning to FIG. 3, a rule 562 corresponding to an embodiment of the present invention is displayed.

In accordance with an embodiment of the present invention, a rule has many informational features associated with it, which can be displayed with the rule in a report. Each rule follows a similar schema, facilitating understanding of the rules. The rule name section 305 provides a short name for the rule. The rule number section 310 displays the number by which the particular rule is referenced. The use checkbox 315 allows a rule to be included in the analysis of patients' data. If the box is checked, then the rule will be evaluated. The update date section 320 shows when the rule was most recently updated. The description section 325 provides an English language description of the rule, and describes the function of the rule. The description section 325 also describes the population of patients that are evaluated under this rule. For example, a rule which deals only with diabetics would only evaluate diabetics.

The settings section 330 allows the rule to be predefined in various ways. The result type section 335 allows the rule to be predefined to various results types. These result types could include for example, yes/no, floating point decimal, a date, or a string of characters. The past medical history type section 340 dictates whether the rule deals with past medical history, so that the results should be stored in duplicate in a more easily accessible location. The writes no result section 345 indicates whether the result of the rule should be indicated if the rule did not apply to the patient. The urgency section 350 is the priority level of the rule. The priority level, for example, could be red, yellow, green, or blue, which correspond to numeric priority values. The retrigger delay section 355 is the amount of time following a successful application of the rule before it will be tested again in the absence of any new health care data. The score for quality section 360 could be used to specify that a rule would be used to help evaluate a patient's overall health as compared to industry “best care” standards. The run group section 365 could be used to identify which group the rule belonged to if the rules were split into groups that could be separately evaluated against the patient data. The cleared by section 370 could be used to specify a follow-up rule that could be used to show that a patient followed the advice provided by this rule.

The messages section 380 contains the text of the messages that relate to the rule. The recipient section 381 within the messages section 380 lists the various entities that message can be addressed to. As an example, the recipient section 381 could include patient, physician or other, which may include a health care provider or insurance company. If multiple messages are included that are addressed to a particular entity, then the Message Group section 382 could be used to indicate which group of messages the particular message belongs to. For example, a group of messages could be for those patients who satisfy the rule. Another group could be those patients who do not satisfy the requirements of the rule. Alternatively, if the rule can be partially satisfied, a message group could be for those patients who partially satisfy the rule. Additionally, the text for each message is indicated within the headline/message section 383. For each message text, a checkbox could be made available under the print message section 384 to indicate whether that message should be printed by default if the rule is satisfied. The maximum message count section 385 could list the maximum number of times the particular message will be reported for a particular patient. The minimum remessage days section 386 could list the minimum number of days before a message could be sent out a second time. Additionally, the response group section 387 is a set of responses available for this message.

The status section 390 describes the state of development of the rule itself, for use during creation of the rule. The rules used section 395 lists the other rules the results of which are used to determine the results of the present rule.

In order to actually apply the rule, the rule must be applied to the historical patient information. For example, In order to determine whether a patient is possibly dependent on a substance, the rule evaluates two pieces of information: past pharmacy claims and active feedback. The rule 562 checks active feedback to verify that there is no active feedback associated with the patient that indicates that the patient is not dependent on a substance. Pharmacy claims for certain medication classes associated with the patient are also checked. The medication classes checked are: (a) narcotics, (b) amphetamines, (c) hypnotics, (d) sedatives, (e) anxiolytics, (f) muscle relaxants, and (g) other miscellaneous medicines. If, in the last 90 days, there are:
(a) 15 or more claims for these medications, or
(b) 8 or more claims for these medications from 4 or more pharmacies, or
(c) 8 or more claims for these medications prescribed by 4 or more physicians,
and there is no active feedback showing the patient not to be dependent on a substance, then the rule returns a ‘yes’ for substance dependency or abuse. This will link the patients unique identification number to a recommendation that reads, “Possible Substance dependency/uncontrolled pain Member's prescription refill pattern for medications with dependency or abuse potential suggests either uncontrolled pain or dependency issue. This can impact all aspects of members' care. Further evaluation is recommended within the next 2 weeks.” This recommendation is aimed at increasing the health of a patient, which, in turn, reduces costs. While it is possible that the recommendation could require an increase in cost at the outset by requiring a substance abuse program, the overall effect of the recommendation would be to reduce costs both for the patient and for the health care provider.

An additional rule, in accordance with an embodiment of the invention, would be a rule identifying patients that might be repeatedly using the emergency room in the hospital for their primary health care. In such a rule, the patient's historical health care data could be evaluated. The required factors could be (a) this patient has been in the Emergency Room since the last analysis, (b) the patient has had more than a defined number (e.g. 2) of emergency room visits in the last 6 months for a treatment that is normally done in a doctor's office, (c) the patient has not been in the Emergency Room in the last 6 months for a treatment that is normally treated in the Emergency Room, and (d) The patient does not have active feedback indicating that this rule does not apply. If a patient fills all these required factors, then a message indicating that they might be using the Emergency Room too frequently could be linked to the patient's unique identification number. An example of this rule can be found below as rule number 638 under the heading Rules with English Language Explanation.

When a report is created for the health care provider, this message will appear with the patient's enrollment or administrative information, so that they can be contacted directly. After direct contact, if it is clear that the patient does not have a dependence on a substance, then active feedback will be associated with the patient's name to this effect. The next time the patient's information is evaluated against this rule, the rule will not attach this recommendation to the patient's information.

In accordance with another embodiment of the present invention, patients' data is analyzed to produce individual recommendations that are communicated to each individual patient. These recommendations can be formatted into a report that addresses multiple issues with regards to the patient's health care. (An example of rules according to an embodiment of the invention that might be used for this can be seen below under the heading Brief Description of the Rules and Identification of the Embodiments to Which they Pertain under checkbox column “2”).

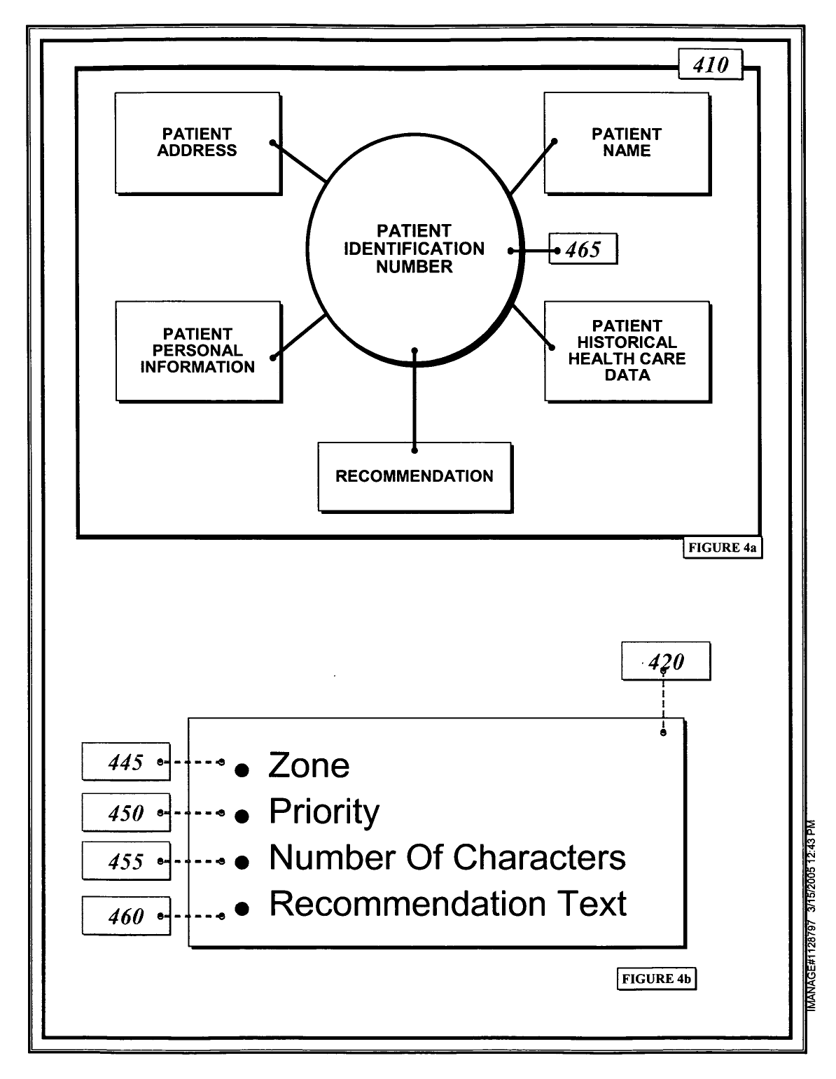

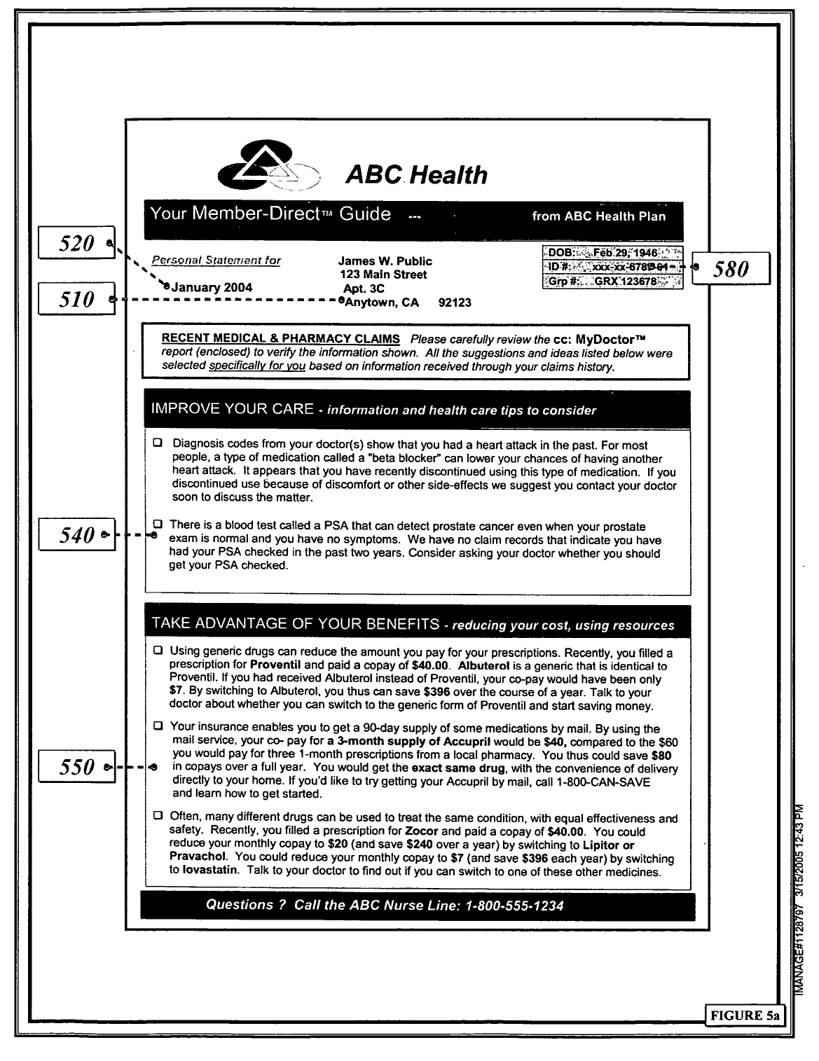

Turning to FIGS. 4a and 4b, recommendations 420 are linked to the patients' data 410 by a recommendation link, which may be, for example patient unique identification number 465. Each recommendation 420 contains information. This may, for example include: (a) Reporting zone 445, which describes where the recommendation will appear on a report, (b) Priority 450, (c) Number of Characters 455, which is used to determine whether a recommendation will fit into the available space on a report, and (d) recommendation text 460. The priority 450 is assigned to the recommendation 420 by the rule which triggered the recommendation 420. In an embodiment, the priority 450 may, for example, be assigned by a physician who decides which rules are most important, and assigns a priority number from, for example, 1 to 100 to each rule. Those skilled in the art will appreciate that priority may be expressed in other ways.

According to an embodiment of the present invention, the priority could be expressed as four discrete levels. This could then be combined with priority weighting based on rule type and certain preferred rules to result in a final priority value for the rule. Additionally, priority could be reduced due to previous inclusion of a recommendation associated with the rule in a report. Following the assignment of priority 450, rules may be applied to actual historical patient information, and the resulting recommendations triggered by the application of those rules are viewed in priority order, from, for example, highest priority (e.g., priority number 1) to lowest priority (e.g., priority number 100). The physician then may verify that the priority order is correct. The priority may be changed to reflect the opinions of different physicians, or to reflect the views of a health plan or insurance company.

The reporting zone 445 relates to each recommendation 420. One or more reports can be generated, including the recommendations linked to each patient's unique identification number. These reports can each contain one or more reporting zones. The reporting zones can function to group similar recommendations together in the report. By way of example, in an embodiment, three reporting zones could be provided. Each recommendation 420 is assigned to a reporting zone 445 based on the content of the recommendation, and the person or entity for whom the recommendation is intended for. In an embodiment, three reporting zones 445 are provided for recommendations. One reporting zone 445, for example, could be dedicated to messages intended for the patient that will help the patient to reduce cost of future health care. An example of such a recommendation could be a recommendation to switch from a name brand drug to a generic drug. A second reporting zone 445, for example, could be for messages intended for the patient that will increase quality of care. An example of this type of message would be a recommendation to ask a doctor about the possibility of using a beta-blocker to lower chances of having a repeat heart attack. The third reporting zone 445 could be for messages intended for the doctor. These messages use terminology that a doctor would understand, and could discuss alternate methods of treatment for the doctor to employ. An example of this type of recommendation would be “Pt. is taking medications prescribed by different physicians. Consider detailed review of all recent meds.” Additional reporting zones could appear on a report that do not have any recommendations assigned to them. This might include a reporting zone for displaying the last 25 claims in a patient's historical health care information, or medical costs paid, for example.

The number of characters 455 is intrinsic to each recommendation, and simply quantifies the size of the given recommendation.

A report may be created for each patient using the patient's name, patient information and the recommendations 420 linked to the patient's unique identification number 465. This first report may for example, be intended for the patient, because the patient is often the decision maker as to which health care options will ultimately be selected for his or her benefit. As such, the information on the report may be created to communicate directly to the patient. Those skilled in the art will appreciate that the report can be intended for any number of different people other than the patient, including other decision makers who may be selecting from among a number of health care options on the patient's behalf.

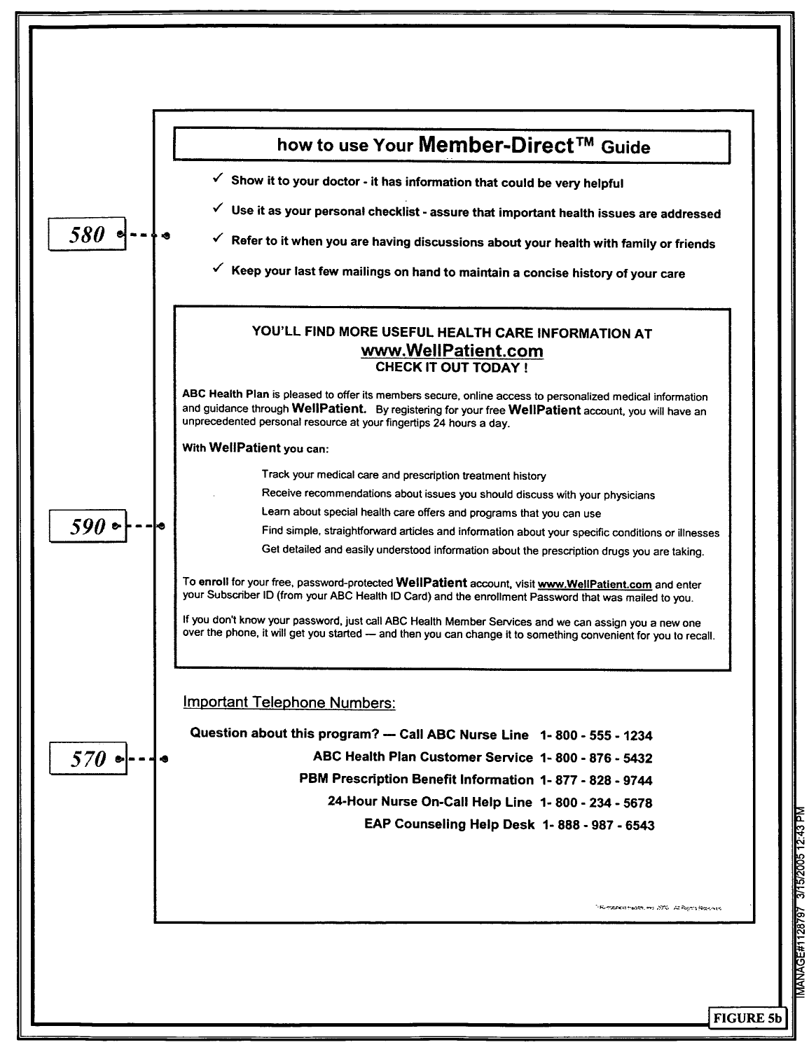

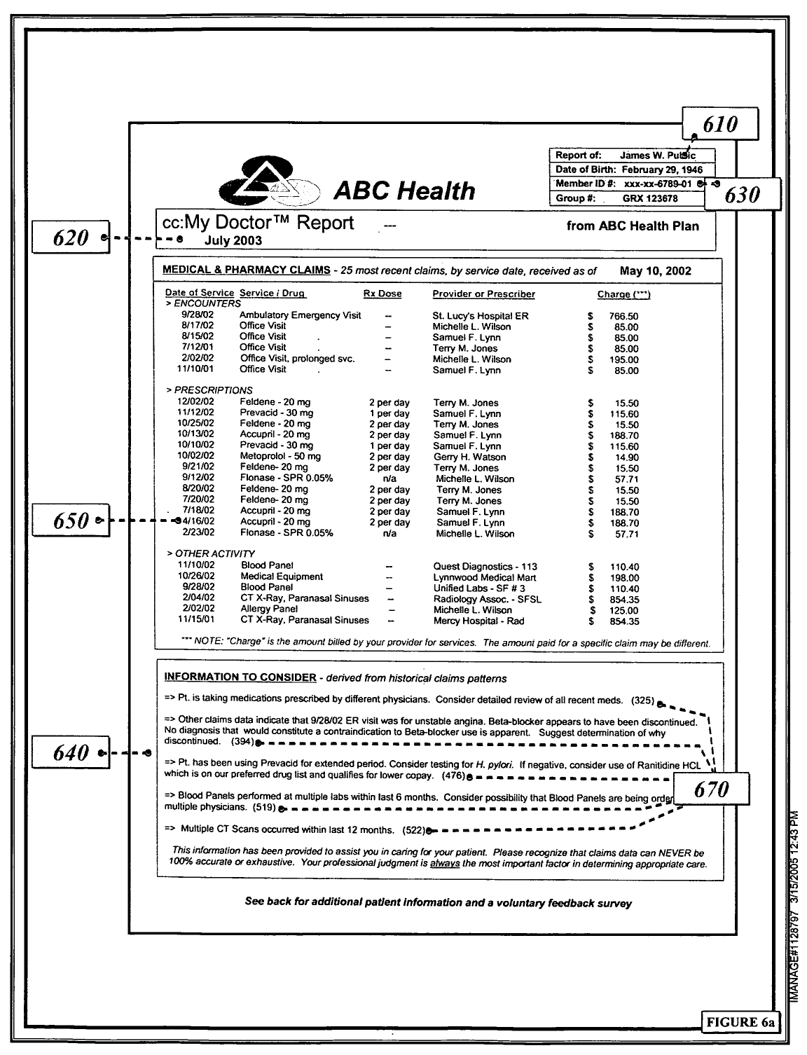

FIG. 5a shows an embodiment of the report intended for the patient. The report may include the following: (a) The patient's name and address 510, (b) The patient's personal information 530, (c) The time period for the report 520, (d) Zone 1 for patient recommendations for clinical improvement 540, (e) Zone 2 for patient recommendations for cost savings or resource offers 550.

The patient's name and address, and personal information are extracted directly from the patient's data 510. The time period for the report can be determined by the current date. The report can be created monthly, quarterly, or yearly, or at any other interval, and the time period for the report can relate to this interval.

Zone 1 for patient recommendation for clinical improvement 540 is filled with recommendation text 460 for those recommendations 420 that correspond to Zone 1 for patient recommendations for clinical improvement 540. When the report is created, it is possible that the patient for whom the report is created has more recommendations 420 that correspond to zone 1 for patient recommendations for clinical improvement 540. In this case, the recommendations 420 are included in the report based on their priority 450.

Zone 2 for patient recommendations for cost savings or resource offers 550 may be filled with recommendation text 460 for those recommendations 420 which correspond to Zone 2 for patient recommendations for cost savings or resource offers 550. When the report is created, it is possible that the patient for whom the report is created has more recommendations 420 that correspond to Zone 2 for patient recommendations for cost savings or resource offers 550. In this case, the recommendations 420 are included in the report based on their priority 450.

In accordance with an embodiment, all the recommendations 420 are ranked according to priority 450 when the report is created. The recommendation 420 with the highest priority 450 is evaluated first. The report zones 540 and 550 may have limited space if, for example, the report is implemented on paper or on some other medium with limited dimensions. Thus the available space for each report zone 540 and 550 may be quantified in terms of the number of characters or lines that can fit within that space. Those skilled in the art will appreciate that there may be other ways that space may be quantified. The recommendation with the highest priority among the recommendations 420 is evaluated to ensure that there is enough space remaining within the appropriate report zone 540 or 550 to fit that recommendation within the appropriate report zone 540 or 550 of the report. Next, the recommendation having the second highest priority 420 among the recommendations 420 with the second highest priority is evaluated to determine whether there is enough space in the appropriate report zone 540 or 550 to include that recommendation. If there is not enough room in the appropriate report zone 540 or 550 to include the recommendation having the third highest priority, then the next recommendation 420 is evaluated. This continues until all of the recommendations 420 have been evaluated.

It is possible in this embodiment that one of the recommendations 420 will be included in the report even if another recommendation 420 having a higher priority is not included within the report. This can occur if the recommendations 420 are associated with different zones, or if the recommendation 420 with the lower priority 450 has a smaller number of characters 455 than a recommendation 420 having a higher priority 450.

While FIG. 5a shows a report that is displayed on a single page, one skilled in the art will recognize that a report could be created to fill any number of pages. The report could also be created and displayed electronically. It should also be clear that the report can include all of the recommendations 420 which are linked to the unique patient identification number 465 by a recommendation link 440.

Turning to FIG. 5b, in an embodiment, the report will include information important to the patient, such as directions on how to use the report 580, alternative methods to have the report conveyed 590, as well as contact information for customer support 570.

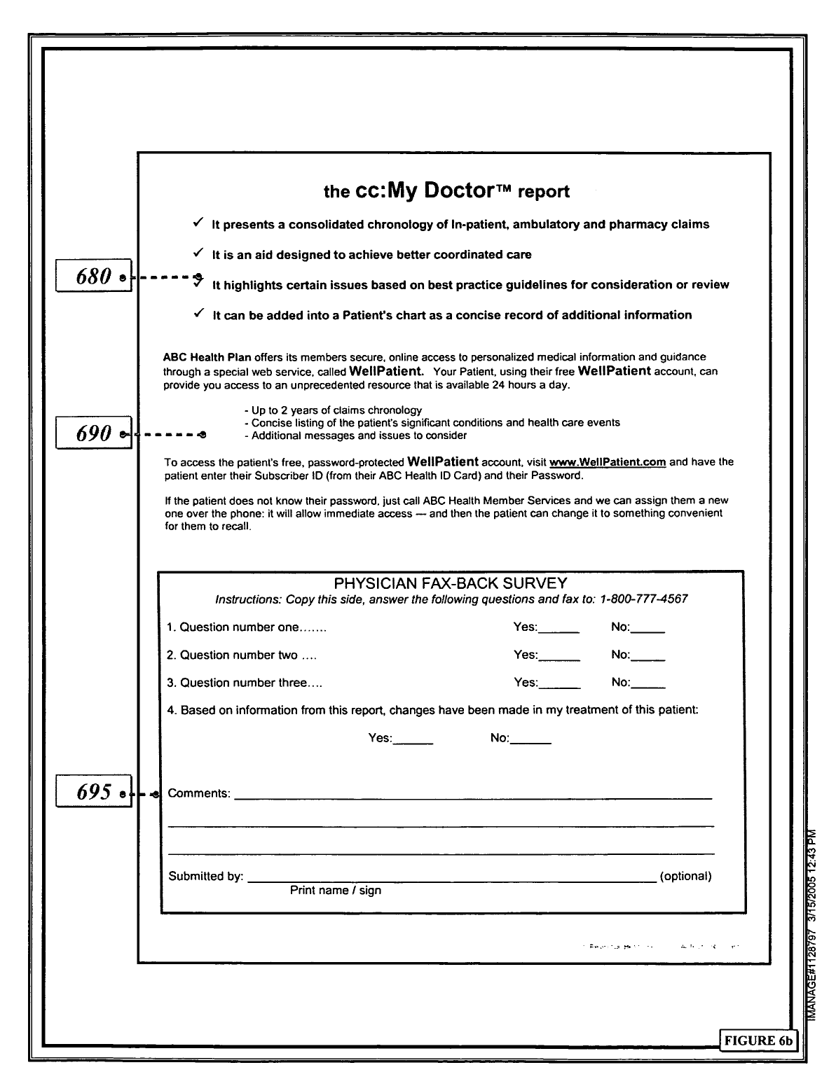

Turning now to FIG. 6a, in an embodiment, a second report can be created. This second report is intended for the doctors or physicians providing care to the patient. This report includes: (a) Patient's name 610, (b) Patient's personal information 630, (c) The time period for the report 520, (d) Selections from historical patient information 650, (e) A zone for physician recommendations 640, The patient's name and personal information are extracted directly from the patient's data 410. The time period for the report 620 is the same as the time period for the report 520 shown on the patient report.

The selections from historical patient information can be selected from among the historical patient information and claims data that is linked to the patient's unique patient identification number. The selection can be selected in many ways. In one embodiment, the most recent 25 health care claims may be included in this section. In another embodiment, all of the patient's pharmacy claims may be included in this section. Alternatively, all of patient's available previous medical history could be presented. This information can help to improve coordination of care for patients being cared for by more than one physician. The reason for this is that the information allows one treating physician to view the treatment provided by other physicians providing treatment for this patient. In that way, any physician, whether primary care or specialist, can provide care in the context of a broader array of health care being provided to that patient.

A zone for physician recommendations 640 is filled with recommendation text 460 for those recommendations 420 that correspond to the zone for physician recommendations 640. When the report is created, it is possible that the patient for whom the report is created has more recommendations 420 that correspond to the zone for physician recommendations 640. In this case, the recommendations 420 are included in the report based on their priority 450.

In accordance with an embodiment of the present invention, the recommendations 420 that are included in the report in the zone for physician's recommendations 640 are determined in the same way that recommendations 420 are selected for the patient's report. In accordance with an embodiment, the recommendation text for the physician's recommendations may include a code number for the recommendation 670 to facilitate the physician contacting the insurance company for further information on the reasons for the display of the recommendation as relates to the particular patient.

While FIG. 6a shows a report that is displayed on a single page, one skilled in the art will recognize that a report could be created to fill any number of pages. The report could also be created and displayed electronically. It should also be clear that the report can include all of the recommendations 420 which are linked to the patient identification number 465 by a recommendation link 440.

Turning to FIG. 6b, in an embodiment, the report will include information important to the physician, such as directions on how to use the report 680, alternative methods to have the report conveyed 690, as well as a survey to provide feedback to the information included in the report 695.

It should be clear to one of skill in the art that the report or reports created can be delivered by many different methods. In an embodiment, the reports are both delivered to the patient by first class mail. When created, each of the reports may be printed on a single sheet of paper, which is separated into, for example two sheets, folded and inserted into an envelope so that the patient's address shows through a window in the envelope. After the patient receives the envelope in the mail, the patient delivers the report intended for the physician directly to the physician. It should be clear that the reports could also be delivered separately to the patient and the physician, or that the reports could both be delivered to the health care provider. The invention is not limited by whom the report or reports are delivered to. Additionally, in one embodiment, the reports are printed on multiple sheets of paper.

It should also be clear to one skilled in the art that the reports could be created and retained on a web server such that individual patients or physicians or health care plan personnel could access the reports through a web browser. The reports could also be delivered by facsimile or by email. The present invention is not limited by the method of delivery of the report.

1. A method of identifying health care options having at least one act implemented in a computer, the method comprising the acts of:
receiving patient information for a first patient,
evaluating said patient information for the first patient to identify a low cost alternative health care option from among a plurality of health care options, and
conveying at least a first recommendation of a group of recommendations relating to said patient information for the first patient, said first recommendation including a recommendation to select the low cost alternative health care option.

2. The method of claim 1, wherein said plurality of health care options includes at least one health care option previously selected by said first patient.

3. The method of claim 1, wherein said plurality of health care options includes at least one health care option previously selected by a doctor of said first patient.

4. The method of claim 1, wherein said group of recommendations is stored in a database.

5. The method of claim 4, wherein the act of conveying comprises the act of:
conveying one or more of said recommendations stored in said database, said one or more of said recommendations including said first recommendation.

6. The method of claim 4, wherein the act of receiving further comprises receiving patient information for a plurality of patients, wherein the act of evaluating further comprises evaluating said patient information for said plurality of patients to identify a low cost alternative health care option for each of said plurality of patients, said low cost alternative health care option being identified from among a plurality of health care options, and wherein the act of conveying further comprises conveying to each of the plurality of patients at least a first recommendation of a group of recommendations relating to said patient information for each of said plurality of patients, said first recommendation including a recommendation to select the low cost alternative health care option.

7. The method of claim 1, wherein the act of conveying comprises creating a report containing said first recommendation, and conveying said report.

8. The method of claim 7, wherein the report is printed on paper.

9. The method of claim 7, wherein the report is electronically generated.

10. The method of claim 1, further comprising the act of:
ranking said group of recommendations according to a predetermined ranking scheme,

11. The method of claim 10, further comprising the acts of:
selecting a subgroup of said group of recommendations according to the result of said act of ranking, said subgroup including the first recommendation.

12. The method of claim 7 wherein said report is conveyed to said first patient.

13. The method of claim 7 wherein said first recommendation contained in said report is intended for said first patient.

14. The method of claim 13 wherein said report further comprises at least a second recommendation intended for a doctor of said first patient.

15. The method of claim 7 wherein said first recommendation contained in said report is intended for a doctor of said first patient.

16. The method of claim 13, further comprising the acts of:
creating a second report containing at least a second recommendation, said second recommendations being intended for a doctor of said first patient, and
conveying said second report.

17. The method of claim 7, wherein the step of conveying comprises the act of:
retaining said report on a web server to enable said report to be accessed by a web browser and to be displayed via said web browser.

18. The method of claim 12 wherein said report is conveyed via email.

19. The method of claim 12 wherein the act of conveying comprises the act of:
retaining said report on a web server to enable said report to be accessed by a web browser and to be displayed via said web browser.

20. The method of claim 16 wherein said first report and said second report are conveyed together via first class mail.

21. The method of claim 16, wherein said first report and said second report are conveyed to said first patient.

22. The method of claim 1, further comprising the act of:
receiving feedback from a doctor of said first patient regarding said first recommendation relating to said patient information for the first patient.

23. The method of claim 1, wherein the step of receiving patient information comprises the acts of:
receiving raw individual patient information from at least one source, and
reformatting said raw individual patient information to conform to a predefined format.

24. The method of claim 1, further comprising the act of:
requesting patient information from at least one source.

25. An apparatus for identifying health care options, the apparatus comprising: one or more computer processors that receive patient information for a first patient, evaluate said patient information for the first patient to identify a low cost alternative health care option from among a plurality of health care options, and initiate conveyance of at least a first recommendation of a group of recommendations relating to said patient information for the first patient, said first recommendation including a recommendation to select the low cost alternative health care option.

26. A computer readable medium for identifying health care options, the computer readable medium having one or more computer modules executable on one or more computer processors, the computer modules carrying out the following acts:
receiving patient information for a first patient,
evaluating said patient information for the first patient to identify a low cost alternative health care option from among a plurality of health care options, and
initiating conveyance of at least a first recommendation of a group of recommendations relating to said patient information for the first patient, said first recommendation including a recommendation to select the low cost alternative health care option.

27. A method of identifying health care options having at least one act implemented on a computer, the method comprising the acts of:
receiving patient information for a first patient,
evaluating said patient information to determine whether one or more health care options may be recommended for the first patient, the one or more health care options having a tendency to lower future health care costs for the first patient, and
recommending said one or more health care options if it is determined that the one or more health care options may be recommended for the first patient.

28. The method of claim 27 wherein said act of evaluating said patient information comprises determining whether the first patient has a health condition necessitating health care for which future health care costs cannot be reduced and determining whether the one or more health care options may be recommended for the first patient only if it is determined that the first patient does not have said health condition.

29. The method of claim 27, wherein said act of evaluating is performed by applying a predefined set of rules.

30. The method of claim 27, wherein the act of receiving further comprises receiving patient information for a plurality of patients including said first patient, and wherein the method further comprises the acts of selecting a subgroup of said plurality of patients having a predetermined characteristic and selecting at least one patient from said subgroup of said plurality of patients for evaluation, said at least one patient being said first patient.

31. The method of claim 27, wherein said patient information includes historical insurance claim information.

32. The method of claim 27, wherein said recommending comprises the acts of:
creating a report containing at least one of said one or more health care options, and
conveying said report.

33. A method of identifying health care options having at least one act implemented on a computer, the method comprising the acts of:
receiving patient information for a first patient,
evaluating said patient information to determine whether one or more health care options may be recommended for the first patient, the one or more health care options having a tendency to improve the quality of health care for the first patient, and
recommending said one or more health care options if it is determined that the one or more health care options may be recommended for the first patient.

34. The method of claim 33, wherein said act of evaluating said patient information comprises determining whether the first patient has a health condition necessitating health care for which future health care costs cannot be reduced and determining whether the one or more health care options may be recommended for the first patient only if it is determined that the first patient does not have said health condition.

35. An apparatus for identifying health care options, the apparatus comprising: one or more computer processors that receive patient information for a first patient, evaluate said patient information to determine whether one or more health care options may be recommended for the first patient, the one or more health care options having a tendency to lower future health care costs for the first patient, and generate a recommendation to select said one or more health care options if it is determined that the one or more health care options may be recommended for the first patient.

36. The apparatus of claim 35, wherein the one or more computer processors, as part of the evaluation of the patient information, determine whether the first patient has a health condition necessitating health care for which future health care costs cannot be reduced and determine whether the one or more health care options may be recommended for the first patient only if it is determined that the first patient does not have said health condition.

37. An apparatus for identifying health care options, the apparatus comprising: one or more computer processors that receive patient information for a first patient, evaluate said patient information to determine whether one or more health care options may be recommended for the first patient, the one or more health care options having a tendency to improve the quality of health care for the first patient, and generate a recommendation to select said one or more health care options if it is determined that the one or more health care options may be recommended for the first patient.

38. The apparatus of claim 37, wherein the one or more computer processors, as part of the evaluation of the patient information, determine whether the first patient has a health condition necessitating health care for which future health care costs cannot be reduced and determine whether the one or more health care options may be recommended for the first patient only if it is determined that the first patient does not have said health condition.

39. A computer readable medium for identifying health care options, the computer readable medium having one or more computer modules executable on one or more computer processors, the computer modules carrying out the following acts:
receiving patient information for a first patient,
evaluating said patient information to determine whether one or more health care options may be recommended for the first patient, the one or more health care options having a tendency to lower fuiture health care costs for the first patient, and
generating a recommendation to select said one or more health care options if it is determined that the one or more health care options may be recommended for the first patient.

40. The computer readable medium of claim 39, wherein said act of evaluating said patient information comprises determining whether the first patient has a health condition necessitating health care for which future health care costs cannot be reduced and determining whether the one or more health care options may be recommended for the first patient only if it is determined that the first patient does not have said health condition.

41. A computer readable medium for identifying health care options, the computer readable medium having one or more computer modules executable on one or more computer processors, the computer modules carrying out the following acts:
receiving patient information for a first patient,
evaluating said patient information to determine whether one or more health care options may be recommended for the first patient, the one or more health care options having a tendency to improve the quality of health care for the first patient, and
generating a recommendation to select said one or more health care options if it is determined that the one or more health care options may be recommended for the first patient.

42. The computer readable medium of claim 41, wherein said act of evaluating said patient information comprises determining whether the first patient has a health condition necessitating health care for which future health care costs cannot be reduced and determining whether the one or more health care options may be recommended for the first patient only if it is determined that the first patient does not have said health condition.
